(19) United States
(12) Patent Application Publication
(10) Pub. No.: US 2011/0027533 A1
(43) Pub. Date: Feb. 3, 2011

(54) GRANULES

(76) Inventors: Keith Kennedy, White Bear Lake, MN (US); Bruce W. Kramer, Stillwater, MN (US)

Correspondence Address: 3M INNOVATIVE PROPERTIES COMPANY, PO BOX 33427, ST. PAUL, MN, 55133-3427, US

(21) Appl. No.: 12/921,881

(22) PCT Filed: Mar. 11, 2009
(86) PCT No.: PCT/US09/36723

§ 371 Date: Oct. 6, 2010

Related U.S. Application Data
(60) Provisional application No. 61/036,182, filed on Mar. 13, 2008.

(51) Int. Cl. B32B 3/10

(52) U.S. Cl. 428/143

(57) ABSTRACT

The present application is directed to a structure comprising a substrate and a structural layer on the substrate. The structural layer comprises a surface opposite the substrate. The structural layer comprises a binder and granules. Generally, the granules are bonded to the substrate with the binder. The granules have a diameter less than 420 micrometers and an average diameter of between 250 and 300 micrometers. Generally, the granule is exposed above the surface of the structural layer.

### FIELD

The present application is in the field of granules useful in construction surfaces, for example roofing shingles.

### BACKGROUND

Many construction surfaces benefit from the addition of granules. For example, asphalt-based roofing materials are a popular medium for covering roofs on homes and other structures. Asphalt-based roofing materials come in shingle or roll form, the shingle being the more widely used material for residential and roll roofing for commercial applications. A typical asphalt shingle or roll has an asphalt substrate and a multitude of granules placed thereon.

Granules come in a variety of colors ranging from white to black. Color has been provided to non-colored (raw) roofing granules in the following manner. Historically, raw granules of about 420-1680 micrometers (40 to 12 US mesh) are preheated to approximately 100°-300° F. (38°-150° C.). A slurry containing a pigment is then applied to the heated granules in a mixer. The color coated granules are then further heated in a kiln to about 350° to 1200° F. (175°-650° C.). This temperature may vary depending on the composition of the slurry. The granules are then cooled to approximately 210°-240° F. (100°-115° C.).

After being colored, the granules may be passed to a post-treatment stage where the granules are treated with an oil. The oil is applied to the colored roofing granules to reduce dust formation. After the oil treatment, the roofing granules are removed from the post-treatment stage, transported, and subsequently applied to an asphalt substrate.

### SUMMARY

The present application is directed to a structure comprising a substrate and a structural layer on the substrate. The structural layer comprises a surface opposite the substrate. The structural layer comprises a binder and granules. Generally, the granules are bonded to the substrate with the binder. The granules have a diameter less than 420 micrometers and an average diameter of between 250 and 300 micrometers. Generally, the granule is exposed above the surface of the structural layer. In some embodiments, the granule has an average diameter of about 266 micrometers. In other embodiments, less than 5% by weight of the granules have a diameter less than 210 micrometers.

### DETAILED DESCRIPTION

The present application is directed to a substrate comprising a structural layer having a surface. The structural layer may be any layer on a substrate, especially those used in construction, and generally comprises granules and a binder. For example, the structural layer may be on an interior or exterior substrate. The structural layer may be horizontal, for example on a floor, a walkway or a roof, or vertical, for example on the walls of a building. For the purpose of the present application, the term “vertical” includes all non-zero slopes.

The material forming the substrate may be internal or external. The substrate may be porous or dense. Specific examples of substrates include, for example, metal, polymeric, concrete and cementitious materials, clay, ceramic (e.g. tiles), natural stone, wood and other non-metals. Specific examples of the substrates include roofs, for example metal roofs, synthetic roofing materials (e.g. composite and polymeric tiles), concrete tiles, clay tiles and asphalt substrates (including filled and polymer modified). Additional specific examples of substrates include architectural wall elements, for example pre-cast concrete panels, molded in place concrete elements, metal cladding, stucco walls and architectural floor elements.

The structural layer of the present application comprises granules. The granule is generally a base material, and may comprise coatings on the base material. Base materials employed in the present application can be the presently known or later-developed base materials. For example, the base material may be of a weather-resistant mineral rock such as greenstone, nephelene syenite, common gravel, slate, gannister, quartz, quartzite, greystone, dacite, andesite, argillite, coal slag, copper slag, nickel slag, etc. Other exemplary base materials are disclosed in U.S. Pat. No. 5,009,511, which are made from recycled materials.

The granules of the present application have a diameter less than 420 micrometers. Generally, the granules have an average diameter of between 250 and 300 micrometers, for example 266 micrometers. Generally, less than 15% by weight of the granules have a diameter less than 210 micrometers, for example less than 10% by weight or less than 5% by weight of the granules having a diameter less than 210 micrometers.

The granules may be coated with a color coating. The color coatings may be ceramic or polymer bound pigments. Examples of color coatings include, for example, those taught in U.S. Pat. Nos. 2,981,636; 3,479,201; and 6,458,642.

The granules may be coated to make the granules solar reflective. See, for example, U.S. Patent Application Publication Numbers 2005-0074580 and 2005-0142329, incorporated by reference herein. For example, the granules may be coated with a first reflective coating on at least a portion of an outer surface of the granule, the coated granule exhibiting a minimum direct solar reflectance value of at least about 25%, and a second reflective coating on at least a portion of the first reflective coating, wherein the combination of the first reflective coating and the second reflective coating provide the granule with at least one of (i) a reflectivity of at least about 20% at substantially all points in the wavelength range between 770 and 2500 nm, and (ii) a summed reflectance value of at least 7000 as measured in the range between 770 and 2500 nm inclusive. A biological inhibitor may also be added to either the first or the second reflective coating.

The granules may be coated with a copper coating. See, for example, U.S. Pat. Nos. 3,528,842; and 5,356,664 incorporated by reference herein. For example, a coating may be on the granules comprising cuprous oxide.

The structural layer or the substrate may additionally comprise a photocatalytic material. Examples of these photocatalytic structures can be found, for example, in U.S. Pat. Nos. 6,881,701 and 6,569,520, incorporated by reference herein. Photocatalytic particles include, but are not limited to, TiO₂, ZnO, WO₃, SnO₂, CaTiO₃, Fe₂O₃, MoO₃, Nb₂O₅, TiₓZr₍₁₋ₓ₎O₂, SiC, SrTiO₃, CdS, GaP, InP, GaAs, BaTiO₃, KNbO₃, Ta₂O₅, Bi₂O₃, NiO, Cu₂O, SiO₂, MoS₂, InPb, RuO₂, CeO₂, Ti(OH)₄, combinations thereof, or inactive particles coated with a photocatalytic coating. The photocatalytic material may be photocatalytic particles on the granules, or photocatalytic coatings within the binder. In some embodiments, the photocatalytic material is a granule having photocatalytic particles coated thereon. In some examples, the photocatalytic material is mixed within a separate layer. For additional specific examples of photocatalytic materials in structural layers and substrates, see, for example, U.S. Patent Application Publication Numbers 2007-0218314, and 2007-0077406, incorporated by reference herein.

The structural layer includes a binder. The binder binds the granules to the surface of the structure. In certain embodiments, the binder is asphalt. In other embodiments, the binder is an adhesive. For example, the adhesive may be a (meth)acrylic adhesive, a urethane adhesive, an epoxy adhesive, a vinyl, or a silicone adhesive. The binder layer is generally binder layer less than 260 micrometers thick. In specific embodiments, the binder layer is less than 254 micrometers thick, for example less than 75 micrometers.

The binder is applied at a thickness that permits sufficient holding properties of the granules but does not completely cover the granules. Generally, the granules are exposed over the surface of the structural layer. For the purpose of the present application, “exposed” means only that the granules protrude from the general plane of the binder opposite the substrate, and not that the granules are exposed to the outside air. For example, 50% of the granules diameter may be above the general plane of the binder. In some embodiments, additional layers are placed on the structural layer opposite the substrate. For example, further polymeric layers may be coated or laminated to the surface of the structural layer. These polymer layers may be synthetic polymers.

In some embodiments, a film layer may be between the structure and the structural layer. Examples of such constructions can be found, for example, in US Patent Application Publication Number 2007-0026195.

As stated above, the granule may be coated with an oil to reduce dust. Additionally, the granule can be isolated in lower dust methods in order to avoid any oil. Such oil-free granules adhere better to certain adhesive binders, especially the adhesives that may be useful on metal substrates.

Various modifications and alterations of the present invention will become apparent to those skilled in the art without departing from the spirit and scope of the invention.

1. A structure comprising a substrate and a structural layer on the substrate, the structural layer comprising:
a surface opposite the substrate;
a binder; and
granules, wherein the granules have a diameter less than 420 micrometers and the granules have an average diameter of between 250 and 300 micrometers and the granule is exposed above the surface of the structural layer.

2. The structure of claim 1 wherein the granule has a base material comprising a mineral rock.

3. The structure of claim 1 wherein the granule comprises a color coating.

4. The structure of claim 1 wherein the granule has an average diameter of about 266 micrometers.

5. The structure of claim 1 wherein less than 5% by weight of the granules have a diameter less than 210 micrometers.

6. The structure of claim 1 wherein the structure is a tile selected from the group consisting of a metal tile, a concrete tile, and a polymeric roofing tile.

7. (canceled)

8. The structure of claim 6 wherein the tile comprises two layers and one layer comprises the granules.

9. The structure of claim 6 wherein the granules are dispersed through the entire thickness of the tile.

10. The structure of claim 1 wherein the structure is horizontal or vertical.

11. (canceled)

12. The structure of claim 1 wherein the structure is a roof, optionally wherein the structure is a metal roof.

13. (canceled)

14. The structure of claim 1 wherein the structure is a roofing shingle, optionally wherein the roofing shingle is a metal shingle, or an asphalt shingle and the binder is asphalt.

15-16. (canceled)

17. The structure of claim 6 wherein the structure is a metal tile.

18. The structure of claim 17 wherein the binder is an adhesive selected from the group consisting of an acrylic adhesive, a urethane adhesive, an epoxy adhesive, a vinyl adhesive, and a silicone adhesive.

19-24. (canceled)

25. The structure of claim 1 wherein the structure is selected from the group consisting of a wall, a floor, an interior construction surface, and an exterior construction surface.

26-28. (canceled)

29. The structure of claim 1 wherein the binder layer is less than 260 micrometers thick.

30. (canceled)

31. The structure of claim 1 comprising a film layer between the substrate and the binder.

32. The structure of claim 1 wherein the granules are oil-free.

33. The structure of claim 1 further comprising a photocatalytic particle.

34. The article of claim 1 wherein the exposed granules are at least 50% above the surface of the structural layer.

35. The article of claim 1 wherein the exposed surface of the granule is solar reflective.
